(19) United States
(12) Patent Application Publication
(10) Pub. No.: US 2010/0037008 A1
(43) Pub. Date: Feb. 11, 2010

(54) APPARATUS WITH A FLASH MEMORY AND METHOD FOR WRITING DATA TO THE FLASH MEMORY THEREOF

(76) Inventor: Keita HATTORI, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/538,262

(22) Filed: Aug. 10, 2009

(30) Foreign Application Priority Data
Aug. 11, 2008 (JP) 2008-207122

(51) Int. Cl. G06F 12/02; G06F 12/00

(52) U.S. Cl. 711/103; 711/E12.001; 711/E12.008

(57) ABSTRACT

An apparatus 1 with a flash memory according to the present invention comprises a flash memory 11 having at least three memory pages 2a, 2b and 2c. Each of the pages 2a, 2b and 2c has a sufficient storage capacity to store an amount of data twice or more that of true data to be written. When the current page is the page 2a (i.e., existing data Dp is stored in the page 2a) and the next page is the page 2b, new data Df is written to the next page 2b and thereafter the data Dp stored in the current page 2a is erased.

### CLAIM OF PRIORITY

The present application claims priority from Japanese patent application serial no. 2008-207122 filed on Aug. 11, 2008, the content of which is hereby incorporated by reference into this application.

### BACKGROUND OF THE INVENTION

1. Field of the Invention

The present invention relates to an apparatus with a flash memory and a method for writing data to the flash memory of the apparatus.

2. Description of Related Art

In recent years, controllers for electronic devices such as MCUs (Micro Controller Unit) have an embedded flash memory (flash ROM) to store various data used by the electronic device. Flash memories are suitable for bulk processing of a large amount of data. Also, conventional controllers for electronic devices have an external EEPROM (Electrically Erasable Programmable Read Only Memory) to process a small amount of data.

Exemplary prior-art disclosures considered relevant to the present invention are:

JP-A-2007-72695; JP-A-2007-41798; JP-A Hei 11(1999)-272566; JP-A Hei 10(1998)-161942; JP-A Hei 10(1998)-124403; JP-A Hei 8(1996)-30515; JP-A Hei 10(1998)-97475; JP-A-2002-268955; JP-A-2003-157204; and JP-A-2005-339450.

As described above, such an EEPROM is externally connected to the controller of an electronic device, thus disadvantageously increasing the number of parts (and therefore the size) of the electronic device or increasing the size of the circuit board for mounting the EEPROM. Even more disadvantageously, EEPROMs are generally large in cell area and therefore expensive because of their manufacturing cost, thus leading to increased overall cost of an electronic device employing such an EEPROM.

To address this problem and to reduce the number of parts and the cost of an electronic device, methods have been proposed in which various data conventionally stored in an external EEPROM are instead stored in a flash memory embedded in an MCU.

FIG. 4 is a flowchart illustrating the operation of a conventional apparatus 41 with a flash memory.

(Step S42): START

The apparatus 41 is powered on.

(Step S43): WRITE REQUEST?

It is determined whether there is a write request to write new data to the flash memory.

(Step S44): ERASE PAGE

When there is a write request (“Yes”) in Step S43, data stored in the page of the flash memory is erased.

(Step 45): WRITE NEW DATA TO PAGE

New data is written to the page.

(Step S46): END

The operation is ended.

(Step S46): END

When there is no write request (“No”) in Step S43, the operation is ended.

As described above, flash memories can be only bulk erased in pages. Therefore, a problem with the above conventional apparatus 41 with a flash memory is that if an accident (such as blackout) occurs during erasing of data stored in the page (in, e.g., Step S44) or during writing of new data to the page (in, e.g., Step S45), part of the data become lost or in the worst case all of the data may become destroyed.

### SUMMARY OF THE INVENTION

In view of the foregoing, it is an objective of the present invention to provide an apparatus with a flash memory and a method for writing data to the flash memory of the apparatus, wherein even if an accident (such as blackout) occurs during writing of new data or during erasing of old data, a state of the flash memory can be restored in which the old data or the new data is stored in the flash memory.

According to a first aspect of the present invention, there is provided an apparatus with a flash memory, the apparatus comprising a flash memory and a controller, wherein said flash memory includes at least three memory pages; and said controller writes new data to a next page of the memory pages while maintaining old data stored in a current page of the memory pages, and thereafter erases the old data.

In the above first aspect of the present invention, the following modifications and changes can be made.

(i) When the apparatus is powered on, said controller determines whether the old data stored in the current page is destroyed; if the old data is not destroyed, said controller determines whether the new data stored in the next page is destroyed; and if the new data is not destroyed, said controller erases the old data in the current page.

(ii) Said controller writes the new data to the memory pages in a predetermined page access order.

(iii) Said controller writes inverted data of the new data to the next page in addition to the new data.

According to a second aspect of the present invention, there is provided a method for writing data to a flash memory of an apparatus, said flash memory including at least three memory pages, wherein the method comprises the successive steps of: writing new data to a next page of the memory pages while maintaining old data stored in a current page of the memory pages, and erasing the old data.

In the above second aspect of the present invention, the following modifications and changes can be made.

(iv) When the apparatus is powered on, the method comprises the steps of: (1) determining whether the old data stored in the current page is destroyed; (2) determining whether the new data stored in the next page is destroyed, if the old data is not destroyed in step (1); and (3) erasing the old data in the current page, if the new data is not destroyed in step (2).

(v) The new data is written to the memory pages in a predetermined page access order.

(vi) In addition to the new data, inverted data of the new data is also written to the next page.

### ADVANTAGES OF THE INVENTION

According to the present invention, even if an accident (such as blackout) occurs to a flash memory during writing of new data or during erasing of old data, a state of the flash memory can be restored in which the old data or the new data is stored in the flash memory.

### BRIEF DESCRIPTION OF THE DRAWINGS

FIG. 1 is a schematic illustration showing a principal configuration and an exemplary write operation of an apparatus with a flash memory according to a preferred embodiment of the present invention; FIGS. 1(a), 1(b), 1(c) and 1(d) illustrate a wait state, a write operation, the completion of a write operation, and an erase operation, respectively.

FIG. 2A is a flowchart illustrating the write operation of the apparatus with a flash memory of FIG. 1, and FIG. 2B is a flowchart illustrating the operation upon power-on.

FIG. 3 is a block diagram of an exemplary electronic apparatus employing the apparatus with a flash memory of FIG. 1.

FIG. 4 is a flowchart illustrating the operation of a conventional apparatus with a flash memory.

### DETAILED DESCRIPTION OF THE PREFERRED EMBODIMENTS

A preferred embodiment of the present invention will be described below with reference to the accompanying drawings. However, the present invention is not limited to the embodiments described herein.

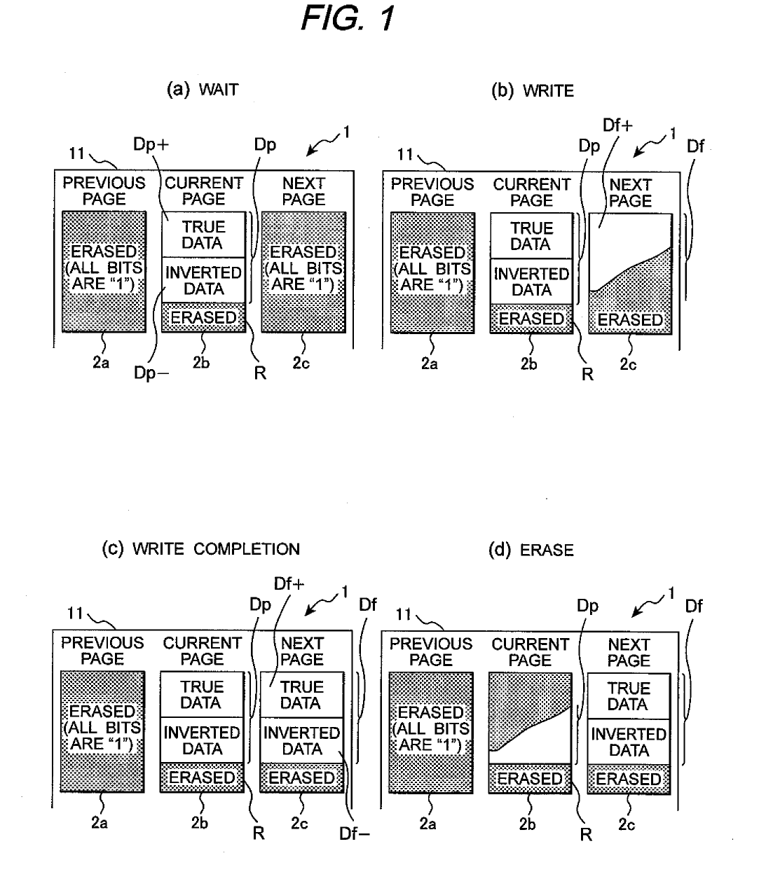

FIG. 1 is a schematic illustration showing a principal configuration of an apparatus with a flash memory according to the present preferred embodiment and an exemplary write operation of the apparatus. FIGS. 1(a), 1(b), 1(c) and 1(d) illustrate a wait state, a write operation, the completion of a write operation, and an erase operation, respectively.

As shown in FIGS. 1(a) to 1(d), an apparatus 1 according to this embodiment comprises a flash memory 11. The flash memory 11 has three pages (storage blocks) 2a, 2b and 2c. However, the flash memory 11 may have four or more pages.

In this embodiment, each of the pages 2a, 2b and 2c has a sufficient storage capacity to store an amount of data twice or more that of true data. In addition to true data, the inverted data obtained by inverting all the bits of the true data is stored in one of the pages. The page size is large enough to store true data, its inverted data, newly added data, and redundant data such as management information stored in a redundant memory area R.

In the flash memory 11, the pages 2a, 2b and 2c are allocated the smallest, middle and largest page addresses, respectively. Upon power on, the page 2a to which the smallest page address is allocated is first accessed. In normal operation, the pages are cyclically accessed in a predetermined order (for example, 2a, 2b, 2c, 2a, 2b, . . . ) For example, if the apparatus 1 is in a wait state as shown in FIG. 1(a) in which existing data is stored in the page 2b (i.e., the current page is the page 2b), the page to which new data is written is changed to the pages 2c, 2a and 2b in this order. In this manner, the three pages 2a-2c are cyclically accessed.

While the flash memory 11 may be of NAND type or NOR type, this embodiment will be described by using an NAND type flash memory, which typically has a relatively large storage capacity. Hereinafter, the term “current page” refers to a page which stores existing data in a wait state; the term “next page” refers to a page which will next be accessed after the current page according to a predetermined page access order; and the term “previous page” refers to a page which has been accessed before the current page has been accessed.

In the apparatus 1 with a flash memory, existing data is stored in the current page which is one of the pages 2a, 2b and 2c, and the other pages (the previous and next pages) have been erased. When writing new data to the flash memory 11, the new data is written to the next page and then the current page is erased. Thereafter, the page to which new data is written is changed according to the predetermined page access order.

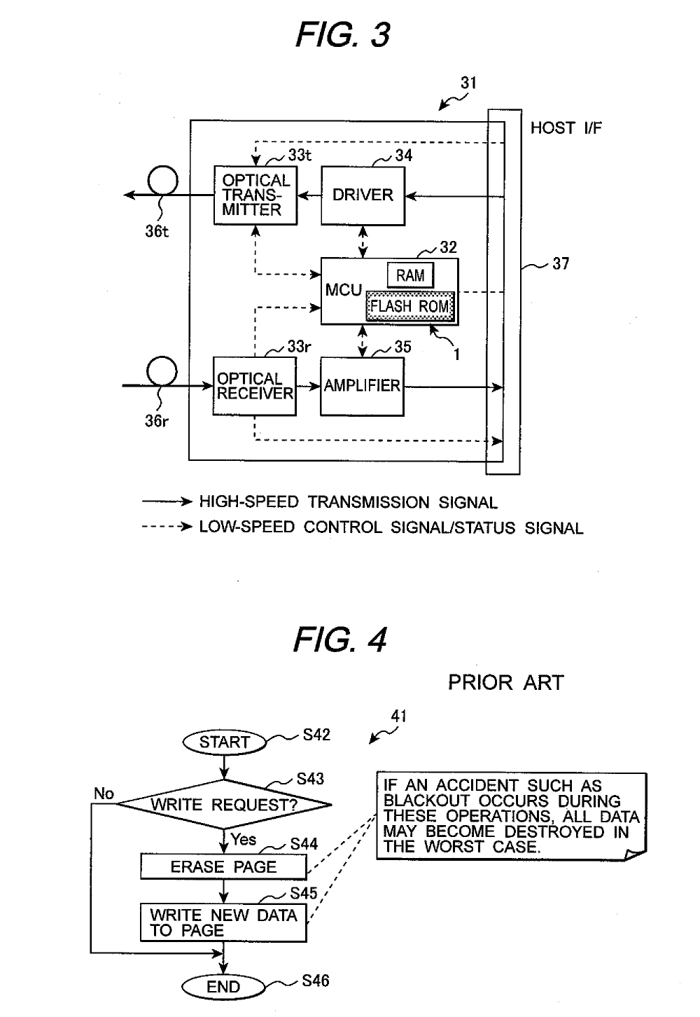

The apparatus 1 may further comprise, in addition to the flash memory 11, a RAM (see FIG. 3 described later, for example). New data is written in the following manner by using, e.g., a programming device such as a writer or a controller such as an MCU of an electronic device. That is, data stored in the current page is copied into the RAM, and next, the data copied into the RAM is modified to create new data, which are then read out of the RAM and stored in the next page. Or alternatively, all new data may be stored into the RAM from the outside.

An example of true data stored in the flash memory 11 is the cumulative monthly usage time of an electronic device. For example, when the cumulative monthly usage time from January to March is existing data, that from January to April becomes new data.

The apparatus 1 with a flash memory determines whether data stored in a page is destroyed. In this embodiment, it is determined whether true data stored in a page matches the inverted data. When matching, it is revealed that the page correctly stores the true data and the inverted data. Thus, it can be determined the data is not destroyed. When not matching, it is revealed that the page does not correctly store the true data and the inverted data. Thus, it can be determined that the data is destroyed. Here, the term “matching” means that true data is equal to data obtained by inverting all the bits of the inverted data.

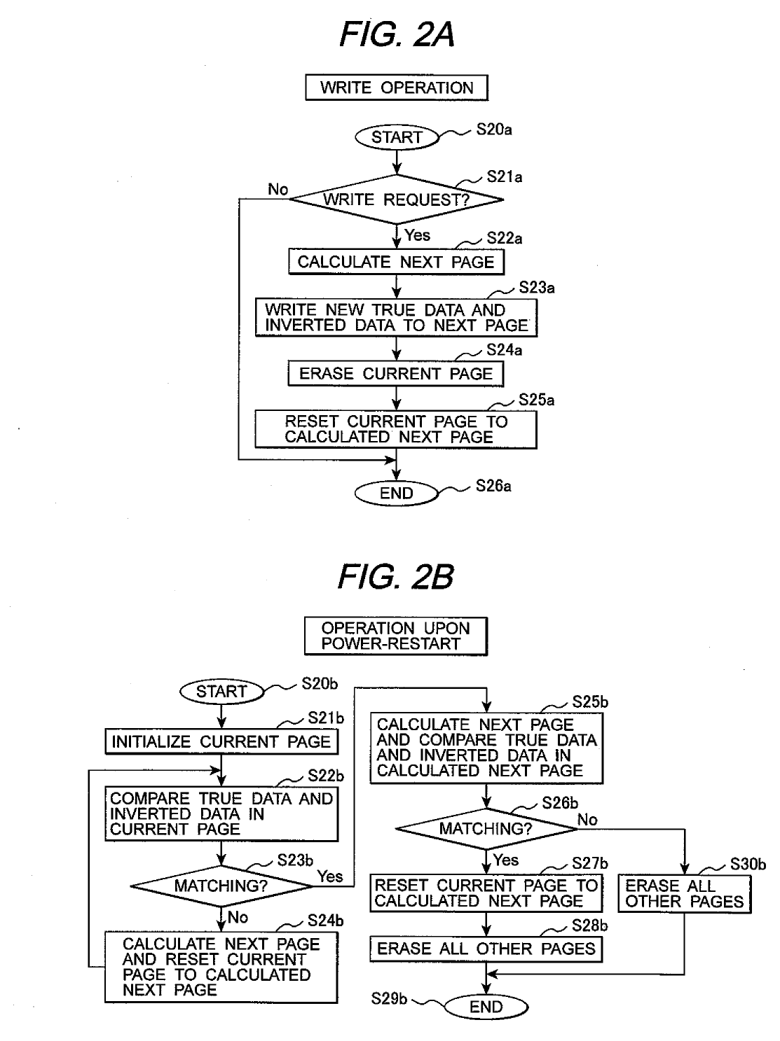

Next, the write operation of the apparatus 1 with a flash memory will be described with reference to FIGS. 1(a)-1(d), and FIGS. 2A and 2B. FIG. 2A is a flowchart illustrating the write operation of the apparatus with a flash memory of FIG. 1, and FIG. 2B is a flowchart illustrating the operation upon power-on.

In the FIG. 1(a) wait state (a state before a write operation), the current, previous and next pages are the pages 2b, 2a and 2c, respectively. The current page 2b stores data Dp including true data Dp+ and its inverted data Dp−. The pages 2a and 2c have been erased (i.e., all the bits are “1”). A series of operations (“erase”, “write”, “calculation of the next page” and “determination”) of the apparatus 1 with a flash memory is performed by means of a programming device such as a writer or a controller such as an MCU of an electronic device.

(Write Operation of New Data)

(Step S20a): START

As shown in FIG. 2A, the write operation of the apparatus 1 with a flash memory starts from a wait state in which data Dp is stored in the current page 2b.

(Step S21a): WRITE REQUEST?

It is determined whether there is a write request to write new data Df to the flash memory 11.

(Step S22a): CALCULATE NEXT PAGE

When there is a write request (“Yes”), the next page is calculated. In FIG. 1(a), the current page is the page 2b; therefore, the next page is calculated to be the page 2c according to the predetermined page access order.

(Step S23a): WRITE NEW TRUE DATA AND INVERTED DATA TO NEXT PAGE

New data Df including the true data Df+ and its inverted data Df− are written to the next page 2c (see FIG. 1(b)). In this embodiment, the true data Df+ is first written and then the inverted data Df− is written (however, even if this writing sequence is reversed, the succeeding operations are the same). FIG. 1(c) corresponds to the state after the completion of this write operation.

(Step S24a): ERASE CURRENT PAGE

The data Dp stored in the current page 2b are erased. In this embodiment, the true data Dp+ is first erased and then the inverted data Dp− is erased (however, even if this erasing sequence is reversed, the succeeding operations are the same). See FIG. 1(d).

(Step S25a): RESET CURRENT PAGE TO CALCULATED NEXT PAGE

The current page is reset to the page 2c (the next page calculated in Step S22a).

(Step S26a): END

The operation is ended.

(Step S26a): END

When there is no write request (“No”) in Step S21a, the operation is ended.

Next, the restoration of the apparatus 1 after power-restart will be described with reference to FIG. 2B. The apparatus 1 with a flash memory performs the operation shown in FIG. 2B when, after a failure such as blackout and accidental power-off occurs during writing of data as described in FIG. 2A, the failure is restored (e.g., when power is turned back on).

(Operation Upon Power-Restart After Power-Off)

(Step S20b): START

The operation is started by powering the apparatus 1 on.

(Step S21b): INITIALIZE CURRENT PAGE

The current page is initialized. In this embodiment, when power is turned on, the page 2a (to which the smallest page address of the flash memory 11 is allocated) is first accessed and the current page is set to the page 2a.

(Step S22b): COMPARE TRUE DATA AND INVERTED DATA IN CURRENT PAGE

The true data and the inverted data are compared in the current page.

(Step S23b): MATCHING?

It is determined whether the true data matches the inverted data in the current page.

(Step S24b): CALCULATE NEXT PAGE AND RESET CURRENT PAGE TO CALCULATED NEXT PAGE

When the matching is not satisfied (“No”) in Step S23b, the next page is calculated, and the current page is reset to the thus calculated next page, and then the operation is returned to Step S22b.

(Step S25b): CALCULATE NEXT PAGE AND COMPARE TRUE DATA AND INVERTED DATA IN CALCULATED NEXT PAGE

When the matching is satisfied in the current page (“Yes”) in Step S23b, the next page is calculated and the true data and the inverted data are compared in the thus calculated next page.

(Step S26b): MATCHING?

It is determined whether the true data matches the inverted data in the calculated next page.

(Step S27b): RESET CURRENT PAGE TO CALCULATED NEXT PAGE

When the true data matches the inverted data in the calculated next page (“Yes”) in Step S26b, the current page is reset to the next page calculated in Step S25b.

(Step S28b): ERASE ALL OTHER PAGES

All the other pages (the previous and next pages) are erased.

(Step S29b): END

The operation is ended.

(Step S30b): ERASE ALL OTHER PAGES

When the true data does not match the inverted data in the calculated next page (“No”) in Step S26b, all the other pages (the previous and next pages) are erased.

(Step S29b): END

The operation is ended.

Next, the procedure for restoring data after a failure such as accidental power-off occurs during the operation of the apparatus 1 with a flash memory will be described in more detail with reference to FIGS. 1(a)-1(d). A power failure may occur during one of the following four periods: during a wait state (FIG. 1(a)); during a write operation (FIG. 1(b)); after the completion of a write operation (FIG. 1(c)); and during an erase operation (FIG. 1(d)). The operation for restoring data is performed according to the flowchart described in FIG. 2B.

(Data Restoration After Power Failure During Wait State of FIG. 1(a))

(Step S20b): START

The apparatus 1 is powered on.

(Step S21b): INITIALIZE CURRENT PAGE

The page 2a to which the smallest page address of the flash memory 11 is allocated is accessed and the current page is set to the page 2a.

(Step S22b): COMPARE TRUE DATA AND INVERTED DATA IN CURRENT PAGE

The true data and the inverted data are compared in the current page 2a.

(Step S23b): MATCHING?

The page 2a has been erased (all the bits are “1”), and therefore it is not determined that the matching is satisfied in the page 2a.

(Step S24b): CALCULATE NEXT PAGE AND RESET CURRENT PAGE TO CALCULATED NEXT PAGE

The next page is calculated to be the page 2b according to the predetermined page access order and the current page is reset to the calculated next page 2b.

(Step S22b): COMPARE TRUE DATA AND INVERTED DATA IN CURRENT PAGE

The true data and the inverted data are compared in the current page 2b.

(Step S23b): MATCHING?

The true data Dp+ matches the inverted data Dp− in the page 2b, and therefore it is determined that the matching is satisfied in the page 2b.

(Step S25b): CALCULATE NEXT PAGE AND COMPARE TRUE DATA AND INVERTED DATA IN CALCULATED NEXT PAGE

The next page is calculated to be the page 2c according to the predetermined page access order, and then the true data and the inverted data are compared in the next page 2c.

(Step S26b): MATCHING?

The page 2c has been erased (all the bits are “1”), and therefore it is not determined that the matching is satisfied in the page 2c.

(Step S30b): ERASE ALL OTHER PAGES

All the other pages (the previous page 2a and the next page 2c) are erased.

(Step S29b): END

The operation is ended.

Thus, the apparatus 1 can be restored to the FIG. 1(a) wait state in which the current page is the page 2b.

(Data Restoration After Power Failure During Write Operation of FIG. 1(b))

(Step S20b): START

The apparatus 1 is powered on.

(Step S21b): INITIALIZE CURRENT PAGE

The page 2a to which the smallest page address of the flash memory 11 is allocated is accessed and the current page is set to the page 2a.

(Step S22b): COMPARE TRUE DATA AND INVERTED DATA IN CURRENT PAGE

The true data and the inverted data are compared in the current page 2a.

(Step S23b): MATCHING?

The page 2a has been erased (all the bits are “1”), and therefore it is not determined that the matching is satisfied in the page 2a.

(Step S24b): CALCULATE NEXT PAGE AND RESET CURRENT PAGE TO CALCULATED NEXT PAGE

The next page is calculated to be the page 2b according to the predetermined page access order and the current page is reset to the calculated next page 2b.

(Step S22b): COMPARE TRUE DATA AND INVERTED DATA IN CURRENT PAGE

The true data and the inverted data are compared in the current page 2b.

(Step S23b): MATCHING?

The true data Dp+ matches the inverted data Dp− in the page 2b, and therefore it is determined that the matching is satisfied in the page 2b.

(Step S25b): CALCULATE NEXT PAGE AND COMPARE TRUE DATA AND INVERTED DATA IN CALCULATED NEXT PAGE

The next page is calculated to be the page 2c according to the predetermined page access order, and then the true data and the inverted data are compared in the calculated next page 2c.

(Step S26b): MATCHING?

The page 2c stores only a part of the set of the true data and the inverted data, and therefore it is not determined that the matching is satisfied in the page 2c.

(Step S30b): ERASE ALL OTHER PAGES

All the other pages (the previous page 2a and the next page 2c) are erased.

(Step S29b): END

The operation is ended.

Thus, the apparatus 1 can be restored to the FIG. 1(a) wait state in which the current page is the page 2b.

(Data Restoration after Power Failure upon Completion of Write Operation of FIG. 1(c))

(Step S20b): START

The apparatus 1 is powered on.

(Step S21b): INITIALIZE CURRENT PAGE

The page 2a to which the smallest page address of the flash memory 11 is allocated is accessed and the current page is set to the page 2a.

(Step S22b): COMPARE TRUE DATA AND INVERTED DATA IN CURRENT PAGE

The true data and the inverted data are compared in the current page 2a.

(Step S23b): MATCHING?

The page 2a has been erased (all the bits are “1”), and therefore it is not determined that the matching is satisfied in the page 2a.

(Step S24b): CALCULATE NEXT PAGE AND RESET CURRENT PAGE TO CALCULATED NEXT PAGE

The next page is calculated to be the page 2b according to the predetermined page access order and the current page is reset to the calculated next page 2b.

(Step S22b): COMPARE TRUE DATA AND INVERTED DATA IN CURRENT PAGE

The true data and the inverted data are compared in the current page 2b.

(Step S23b): MATCHING?

The true data Dp+ matches the inverted data Dp− in the page 2b, and therefore it is determined that the matching is satisfied in the page 2b.

(Step S25b): CALCULATE NEXT PAGE AND COMPARE TRUE DATA AND INVERTED DATA IN CALCULATED NEXT PAGE

The next page is calculated to be the page 2c according to the predetermined page access order, and then the true data and the inverted data are compared in the calculated next page 2c.

(Step S26b): MATCHING?

The true data Df+ matches the inverted data Df− in the page 2c, and therefore it is determined that the matching is satisfied in the page 2c.

(Step S27b): RESET CURRENT PAGE TO CALCULATED NEXT PAGE

The current page is reset to the next page 2c calculated in Step S25b.

(Step S28b): ERASE ALL OTHER PAGES

All the other pages (the previous page 2b and the next page 2a) are erased.

(Step S29b): END

The operation is ended.

Thus, the apparatus 1 can be restored to a wait state in which the current page 2c stores new data.

(Data Restoration after Power Failure during Erase Operation of FIG. 1(d))

(Step S20b): START

The apparatus 1 is powered on.

(Step S21b): INITIALIZE CURRENT PAGE

The page 2a to which the smallest page address of the flash memory 11 is allocated is accessed and the current page is set to the page 2a.

(Step S22b): COMPARE TRUE DATA AND INVERTED DATA IN CURRENT PAGE

The true data and the inverted data are compared in the current page 2a.

(Step S23b): MATCHING?

The page 2a has been erased (all the bits are “1”), and therefore it is not determined that the matching is satisfied in the page 2a.

(Step S24b): CALCULATE NEXT PAGE AND RESET CURRENT PAGE TO CALCULATED NEXT PAGE

The next page is calculated to be the page 2b according to the predetermined page access order and the current page is reset to the calculated next page 2b.

(Step S22b): COMPARE TRUE DATA AND INVERTED DATA IN CURRENT PAGE

The true data and the inverted data are compared in the current page 2b.

(Step S23b): MATCHING?

The page 2b stores only a part of the set of the true data and the inverted data, and therefore it is not determined that the matching is satisfied in the page 2b.

(Step S24b): CALCULATE NEXT PAGE AND RESET CURRENT PAGE TO CALCULATED NEXT PAGE

The next page is calculated to be the page 2c according to the predetermined page access order and the current page is reset to the calculated next page 2c.

(Step S22b): COMPARE TRUE DATA AND INVERTED DATA IN CURRENT PAGE

The true data and the inverted data are compared in the current page 2c.

(Step S23b): MATCHING?

The true data Df+ matches the inverted data Df− in the page 2c, and therefore it is determined that the matching is satisfied in the page 2c.

(Step S25b): CALCULATE NEXT PAGE AND COMPARE TRUE DATA AND INVERTED DATA IN CALCULATED NEXT PAGE

The next page is calculated to be the page 2a according to the predetermined page access order, and then the true data and the inverted data are compared in the calculated next page 2a.

(Step S26b): MATCHING?

The page 2a has been erased (all the bits are “1”), and therefore it is not determined that the matching is satisfied in the page 2a.

(Step S30b): ERASE ALL OTHER PAGES

All the other pages (the previous page 2b and the next page 2a) are erased.

(Step S29b): END

The operation is ended.

Thus, the apparatus 1 can be restored to a wait state in which the current page 2c stores new data.

As described above, in the apparatus 1 with a flash memory of this embodiment, even if a failure such as blackout and accidental power-off occurs during a series of operations for writing new data (i.e., during a wait state; during a write operation; after the completion of a write operation; and during an erase operation), a state of the apparatus 1 can be restored in which the true data and the inverted data (which have been stored before the occurrence of the failure) are stored in the current page.

The FIG. 2B procedures can be used for the power-on operation of an electronic apparatus equipped with the apparatus 1 with a flash memory after replacement or initial installation. However, there are cases that no data is (or needs to be) prestored in the flash memory of such an electronic apparatus before shipment. A problem here is that all of the three pages of the flash memory store no data, and therefore the FIG. 2B operation may potentially enter a troublesome infinite loop. This problem can be prevented by prestoring, before shipment, dummy data in one page of the flash memory so that the flash memory is placed in a wait state such as that shown in FIG. 1(a). And alternatively, the FIG. 2B operation may be modified so that when none of the three pages satisfies the matching, the current page is set to a predetermined page (e.g., the page 2a) and then the operation is ended.

The apparatus 1 with a flash memory requires no external EEPROM in addition to the flash memory 11. Therefore, the number of parts can be reduced, thus leading to high mounting density and cost reduction.

Also, by using the three memory pages 2a, 2b and 2c and the procedures shown in the FIG. 2B flowchart, the apparatus 1 with a flash memory can restore, even after a power failure, an apparatus state in which the true data and the inverted data which have been stored before the occurrence of the failure are stored in the current page. If only two pages are used, the following problem arises: That is, if power goes off after the completion of a write operation, it cannot be determined which page stores the latest data because both pages store meaningful data; as a result, the data restoration fails. To prevent this problem, the following measure is needed: That is, the two pages are each provided with an additional memory area for storing the page access number, and when new data is written to a page, the page access number is also written to the additional memory area. In contrast, the apparatus 1 with a flash memory according to this embodiment does not require such a measure (i.e., storing the page access number in an additional memory area provided in each page). If power goes off before the completion of writing of new data, the apparatus 1 with a flash memory can restore, according to the predetermined procedures, a wait state in which the current page is the page storing the old data. If power goes off after the completion of writing of new data, the apparatus 1 can restore a wait state in which the current page is the page storing the new data.

As an example of such an electronic apparatus equipped with the apparatus 1 with a flash memory, an optical module is described with reference to FIG. 3. FIG. 3 is a block diagram of an exemplary electronic apparatus employing the apparatus with a flash memory of FIG. 1.

As shown in FIG. 3, an optical module 31 is an SFP (Small Form Factor Pluggable) optical transceiver for greater than 10 Gbit/s transmission. The optical module 31 is controlled by a single-chip controller (MCU) 32 having integrated therein the apparatus 1 with a flash memory.

The optical module 31, in addition to the controller 32, includes: an optical transmitter 33t (such as a TOSA [transmitting optical sub-assembly]) for converting electrical signal to optical signal and transmitting the optical signal; a driver 34 for driving and modulating an LD (semiconductor laser diode) of the transmitter 33t; an optical receiver 33r (such as an ROSA [receiving optical sub-assembly]) for converting received optical signal to electrical signal; and an amplifier 35 for amplifying the electrical signal from a PD (photo diode) of the receiver 33r. While, in the FIG. 3 example, the ROSA 33r and the amplifier 35 are separate, the amplifier 35 may be contained in the ROSA 33r.

The module units (the optical transmitter 33t, the driver 34, the optical receiver 33r and the amplifier 35) are connected to the controller 32, and low-speed control signals and status signals are exchanged between each of these module units and the controller 32. A transmitting optical fiber 36t, which serves as an optical transmission line, is connected to the optical transmitter 33t, and a receiving optical fiber 36r, which serves as an optical transmission line, is connected to the optical receiver 33r.

The optical module 31 is provided with a card edge connector 37, into which is insertable a host apparatus such as a switching hub and a media converter. Thus, the controller 32, the optical transmitter 33t, and the optical receiver 33r can be electrically connected to a host apparatus via the connector 37, and thereby low-speed control signals and status signals can be exchanged between each of these module units 32, 33t, and 33r and the host apparatus. The driver 34 and the amplifier 35 can also be connected to a host apparatus via the connector 37, and thereby high-speed transmission signals can be exchanged between the host apparatus and these units 34 and 35.

In the controller 32 of the optical module 31, a firmware (embedded software) program is stored in the flash memory (flash ROM) 1 according to the present invention. Conventionally, such a firmware program is stored in an external EEPROM. As described in this example, the apparatus 1 with a flash memory according to the present invention is integrated in a single-chip MCU and a firmware program is stored in the flash memory of the apparatus 1; thereby, a conventionally used external EEPROM can be removed. Therefore, high mounting density and cost reduction can be achieved while ensuring data restoration from a system failure. Thus, the apparatus 1 with a flash memory according to the present invention can be advantageously employed in the optical module 31.

In the optical module 31, examples of true data stored in the apparatus 1 include: initial configuration data such as the type and manufacturing date of the optical module 31; and user data written by the user such as the cumulative usage time and the error signal history.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus with a flash memory, comprising a flash memory and a controller, wherein:
said flash memory includes at least three memory pages; and
said controller writes new data to a next page of the memory pages while maintaining old data stored in a current page of the memory pages, and thereafter erases the old data.

2. The apparatus with a flash memory according to claim 1, wherein:
when the apparatus is powered on, said controller determines whether the old data stored in the current page is destroyed;
if the old data is not destroyed, said controller determines whether the new data stored in the next page is destroyed; and
if the new data is not destroyed, said controller erases the old data in the current page.

3. The apparatus with a flash memory according to claim 1, wherein:
said controller writes the new data to the memory pages in a predetermined page access order.

4. The apparatus with a flash memory according to claim 1, wherein:
said controller writes inverted data of the new data to the next page in addition to the new data.

5. A method for writing data to a flash memory of an apparatus, said flash memory including at least three memory pages,
the method comprising the successive steps of:
writing new data to a next page of the memory pages while maintaining old data stored in a current page of the memory pages, and
erasing the old data.

6. The method according to claim 5, wherein
when the apparatus is powered on, the method comprises the steps of:
(1) determining whether the old data stored in the current page is destroyed;
(2) determining whether the new data stored in the next page is destroyed, if the old data is not destroyed in step (1); and
(3) erasing the old data in the current page, if the new data is not destroyed in step (2).

7. The method according to claim 5, wherein:
the new data is written to the memory pages in a predetermined page access order.

8. The method according to claim 5, wherein:
inverted data of the new data is also written to the next page in addition to the new data.
